(19) United States
(12) Patent Application Publication
(10) Pub. No.: US 2026/0152974 A1
(43) Pub. Date: Jun. 4, 2026

(54) MOTOR VEHICLE LOCK, IN PARTICULAR MOTOR VEHICLE DOOR LOCK

(71) Applicant: KIEKERT AKTIENGESELLSCHAFT, Heiligenhaus (DE)

(72) Inventors: Holger SCHIFFER, Meerbusch (DE); Michael SCHOLZ, Essen (DE); Peter SZEGENY, Engelskirchen (DE); Ömer INAN, Dorsten (DE)

(73) Assignee: KIEKERT AKTIENGESELLSCHAFT, Heiligenhaus (DE)

(21) Appl. No.: 18/718,984

(22) PCT Filed: Aug. 26, 2022
(86) PCT No.: PCT/DE2022/100638

§ 371 Date: Jun. 19, 2024

(30) Foreign Application Priority Data
Dec. 21, 2021 (DE) 10 2021 133 964.2

(51) Int. Cl. E05B 81/16; E05B 77/28; E05B 81/08

(52) U.S. Cl. CPC E05B 81/16; E05B 77/28; E05B 81/08

(57) ABSTRACT

A motor vehicle lock, in particular a motor vehicle door lock, which is equipped with an actuating lever chain with at least one locking lever and a securing lever, for example an anti-theft lever. Furthermore, at least one electromotive drive is provided for acting upon the securing lever and/or the locking lever. According to the invention, a control lever is additionally implemented for coupling/uncoupling the locking lever, wherein the control lever can be acted upon by means of both the motor-operated anti-theft lever and an electromagnetic unit.

The invention relates to a motor vehicle lock, in particular a motor vehicle door lock, having an actuating lever chain with at least one locking lever and a securing lever, for example an anti-theft lever, and having at least one electromotive drive for actuating the securing lever and/or the locking lever.

Motor vehicle locks and especially motor vehicle door locks can typically not only be unlocked and locked, but also have an anti-theft function. For the unlocking and locking using the locking lever, an external actuating lever chain of the corresponding motor vehicle lock is mechanically interrupted or closed. The interrupted state is associated with the “locked” position. In this position, when the external actuating lever chain is actuated by, for example, an external door handle, a locking mechanism acted on by the actuating lever chain consisting of a rotary catch and a pawl-cannot be opened starting from its closed state. In this case, the locking lever is uncoupled, so that the described action on the outside door handle corresponds to a free travel on the locking lever, which consequently does not transmit the actuating movement any further. In contrast, an internal actuating lever chain is typically still effective without change, so that the motor vehicle lock in question can be opened from the inside, for example via an interior door handle.

If an anti-theft protection function is additionally implemented using an anti-theft lever, the “secured” functional position of the anti-theft lever corresponds to the fact that both the internal actuating lever chain and the external actuating lever chain are mechanically interrupted. For this purpose, the locking lever on the external actuating lever chain is uncoupled. A corresponding locking lever of the internal actuating lever chain is also uncoupled. As a result, the associated motor vehicle lock cannot be opened from the inside or outside, thus providing effective anti-theft protection.

In principle, the securing lever can also be a child lock lever. In this case, the “secured” functional position corresponds to the fact that an internal actuating lever chain on the rear motor vehicle side doors is mechanically interrupted, whereas the associated external actuating lever chain still enables the respective rear motor vehicle side door to be opened.

In a motor vehicle lock of the design described above, as described, for example, in WO 2021/110206 A1 of the applicant, the securing lever can be actuated by means of a motor drive, and additionally by an emergency actuation lever. The securing lever has a spring for its positioning.

The prior art has proven itself in principle, but still offers room for improvement. The locking lever and the securing lever and/or anti-theft lever are usually functionally coupled to each other. For example, in the previously mentioned and generic prior art, the two levers are mounted on the same axis as each other. In practice, however, there are also requirements which make a functional separation between the locking function on the one hand, and the anti-theft function or the security function in general on the other, desirable. For example, it should be possible to generally switch from the “secured” or “theft-proof” functional position to the “locked” position. There are currently no convincing solutions to this problem.

The invention is based on the technical problem of further developing such a motor vehicle lock and in particular a motor vehicle door lock in such a way that the locking lever and the securing lever can be functionally separated from one another, and thus it is possible, for example, to change from the “secured” functional position to the “locked” functional position.

To solve this technical problem, the invention proposes, proceeding from a generic motor vehicle lock and in particular a motor vehicle door lock, that a control lever is provided for coupling/uncoupling the locking lever, wherein the control lever can be actuated both by means of the motor-operated anti-theft lever and by an electromagnetic unit.

According to the invention, the control lever is not only activated by the motor-operated securing lever-and in particular, the anti-theft lever. Rather, for coupling/uncoupling the locking lever, the control lever can also be additionally and independently magnetically actuated by an electromagnetic unit. By means of this electromagnetic unit, the control lever in question, which is usually made of metal and/or is magnetizable, can be attracted / held in place when the electromagnetic unit is energized. However, if the electromagnetic unit is not energized or is de-energized, the control lever remains unaffected.

As a result, according to an advantageous design, the motor-operated securing lever, in a “secured” first actuating direction, forces the control lever to uncouple the locking lever. This means that, as soon as the securing lever is moved in this first “secured” actuating direction using the electromotive drive, this leads to the control lever being acted upon and/or usually pivoted in such a way that the locking lever is uncoupled as a result. As a result, not only is the securing lever in its “secured” position, but the locking lever is also uncoupled, so that overall, and in the example, both an internal actuating lever chain and an external actuating lever chain are each mechanically interrupted, and the “theft-proof” or “secured” functional state corresponds to this situation.

In addition, the motor-operated securing lever can be moved in a second “unsecured” actuating direction opposite to the first actuating direction using the electromotive drive. In this second actuating direction, the securing lever is “unsecured” and the securing lever does not act on the control lever. Rather, in this second actuating direction, the securing lever is “unsecured” only by means of the electromagnetic unit. The design is such that the control lever couples the locking lever in the second actuating direction of the securing lever and when the electromagnetic unit is not energized. When the electromagnetic unit is energized, however, the locking lever is uncoupled.

The coupled locking lever corresponds to the “unlocked” position, i.e. the associated actuating lever chain and in particular the external actuating lever chain is mechanically closed. In contrast, the uncoupled locking lever corresponds to the “locked” position. In this case, the actuating lever chain and/or external actuating lever chain in question is mechanically interrupted.

Based on the functional sequences described above, it is clear that according to the invention it is possible to switch directly from the “secured” or “anti-theft device on” functional position to the “locked” or “unlocked” position. In order to leave the “secured” functional position or “anti-theft protection”, it is only necessary that the motor-operated securing lever is actuated in the second, “unsecured” actuating direction. As a result, the control lever is not acted upon. Depending on whether the electromagnetic unit remains energized or de-energized, the control lever is actuated or not actuated accordingly. When the electromagnetic unit is de-energized, the control lever is not mechanically attracted by the electromagnetic unit, and ensures that the locking lever (optionally spring-assisted) is coupled. This is because the control lever in question is usually equipped with a spring that biases the control lever towards a coupled position of the locking lever. Consequently, if the control lever is not acted upon by either the motor-operated securing lever or the non-energized electromagnetic unit, it assumes the position predetermined by the spring, thus ensuring that the locking lever is coupled. As a result, the associated actuating lever chain and in particular the external actuating lever chain is in its “unlocked” position.

However, if the electromagnetic unit is energized after the securing lever has been actuated by the motor in the second, “unsecured” actuating direction, it ensures that the control lever is magnetically attracted and held in place. As a result, the control lever ensures that the locking lever is uncoupled. During this process, the energized electromagnetic unit must overcome the force of the spring assigned to the control lever.

Since in this functional position the locking lever is uncoupled when the electromagnetic unit is energized, the associated actuating lever chain or external actuating lever chain is in its “locked” state. It is therefore possible within the scope of the invention, for example, to switch from the “anti-theft device on” functional position to the “locked” functional position. This usually requires the securing lever to be actuated by an electric motor and the electromagnetic unit to be energized. Both processes can be carried out separately from each other and/or implemented by a staggered activation.

This means that as soon as the motor-operated securing lever is compelled into its second, “unsecured” actuating direction, the electromagnetic unit effectively takes over the function of a “switch.” If, starting from this functional position, the electromagnetic unit is not energized or remains de-energized, the control lever remains in its basic position predetermined by the associated spring, and the locking lever is thereby coupled. The corresponding actuating lever chain is “unlocked.” If, on the other hand, the electromagnetic unit is energized, this corresponds to the uncoupled position of the locking lever, and the associated actuating lever chain or external actuating lever chain is in its “locked” functional position.

Furthermore, and according to a further advantageous embodiment, the locking lever is uncoupled during normal operation and when the electromagnetic unit is energized, and assumes its “locked” functional position. This means that the energized electromagnetic unit ensures that the control lever is compelled and/or pivoted against the force of the spring assigned to it, and, as a result, the locking lever is uncoupled. Any action on the associated actuating lever chain or external actuating lever chain is therefore ineffective because the actuating lever chain in question is mechanically interrupted.

However, if there is a failure of the power supply to the electromagnetic unit, for example due to a voltage drop or a malfunction of a battery or accumulator in the vehicle, or because supply lines are interrupted due to an accident or crash, the design is such that the locking lever immediately returns to its coupled, “unlocked” position in emergency operation. This is because the failure of the power supply and the loss of power to the electromagnetic unit means that the electromagnetic unit can no longer magnetically attract the control lever.

As a result, the spring assigned to the control lever ensures that the control lever assumes its basic position, corresponding to the coupled position of the locking lever. The corresponding actuating lever chain is therefore immediately unlocked in such a case and/or in emergency operation, for example in the event of an accident or crash. This is of particular importance in order to allow rescue personnel arriving at the scene of an accident, for example following such an accident, unhindered access to the interior of the vehicle and thus to any persons who may have been involved in the accident. Because the actuating lever chain is automatically unlocked in such a case, the corresponding motor vehicle door can be easily opened, for example, using an outside door handle or an emergency operating handle.

As a rule, the securing lever is designed to be largely linear. The locking lever is generally mounted on the securing lever. At this point, a rotating mount can be provided and implemented. In addition, the design is usually such that a control pin of the control lever engages in an actuating contour on the locking lever. The actuating contour is generally L-shaped, so that, according to the position of the control pin inside this actuating contour, the different “coupled” or “uncoupled” functional positions of the locking lever, and a corresponding free travel, can be realized and implemented. This will be explained in more detail below with reference to the description of the figures. In addition to the electromotive drive for the securing lever and/or anti-theft lever, a second electromotive drive can be implemented for the locking lever.

In the following, the invention is explained in more detail with the aid of a drawing showing only an exemplary embodiment; in the figures:

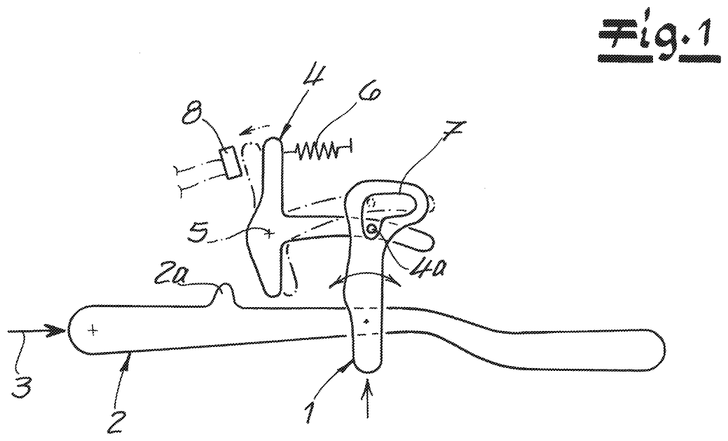

FIG. 1 shows the motor vehicle lock according to the invention, and in particular the motor vehicle door lock in the “unsecured” state and with the locking lever coupled, and

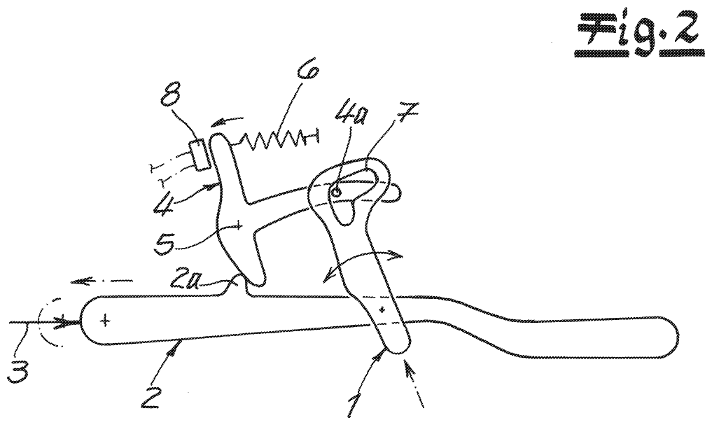

FIG. 2 shows the subject matter according to FIG. 1, in the “secured” functional position.

The drawings show a motor vehicle lock which is not limited to a motor vehicle door lock. For this purpose, the motor vehicle lock shown is equipped with an actuating lever chain 1, 2 with a locking lever 1 and a securing lever 2. The securing lever 2 is an anti-theft lever 2; this is not limiting. In principle, the securing lever 2 can also be designed as a child lock lever-which, however, is not shown. In addition to the actuating lever chain 1, 2, at least one electromotive drive 3 is realized, with the help of which the securing lever 1 can be actuated according to the embodiment. For this purpose, the electromotive drive 3 acts on the securing lever 2 in such a way that the securing lever 2 is largely displaced linearly in the direction of the arrow indicated in FIG. 1, so that as a result the securing lever 2 is transferred from its position according to the illustration in FIG. 1 to that in FIG. 2.

According to the invention, a control lever 4 is additionally realized. The locking lever 1 can be coupled or uncoupled using the control lever 4, as will be explained in more detail below. For this purpose, the control lever 4 is mounted such that it can rotate about an axis 5. In addition, the control lever 4 is assigned a spring 6 which moves the control lever 4 in the absence of external actuation into the position shown in solid lines in FIG. 1.

The control lever 4 is equipped at one end with an end-face control pin 4a. The control pin 4a of the control lever 4 engages in an actuating contour 7 in or on the locking lever 1. According to the embodiment, the actuating contour 7 is designed in the shape of an L.

If the control pin 4a is in its position shown in FIG. 1 at the lower end of the predominantly vertical L-leg, an actuation of the locking lever 1 indicated there by an arrow results in the locking lever 1 being able to follow the actuation, and accordingly the associated actuating lever chain 1, 2 is “coupled.” This allows a locking mechanism (not expressly shown) consisting substantially of a rotary catch and a pawl to be opened from its closed state by means of the actuating lever chain 1, 2. This is because the locking lever 1, which is in its coupled position, and the actuating lever chain 1, 2 which is closed in this way, allow the pawl (not expressly shown) to be lifted from its engagement with the rotary catch. The catch opens with the aid of a spring and releases a previously caught locking pin. The associated motor vehicle door can be opened. This includes, as mentioned, the “unsecured” functional state of the actuating lever chain 1, 2, and consequently the coupled position of the locking lever 1.

If, on the other hand, the control pin 4a is located in the upper and predominantly horizontally arranged leg of the L-shaped actuating contour 7 of the locking lever 1, the indicated action on the locking lever 1 results in the latter performing a free movement with respect to the actuating lever chain 1, 2. As a result, the locking mechanism, which is not expressly shown, cannot be opened and remains in its closed position. This corresponds to the uncoupled position of the locking lever 1 and, accordingly, the “locked” state of the actuating lever chain 1, 2.

According to the invention, the control lever 4 can then be actuated both by means of the motor-operated anti-theft lever 2 and by means of an additionally provided electromagnetic unit 8. The electromagnetic unit 8 has an electromagnet, by means of which the metallic and/or magnetizable control lever 4 is magnetically attracted. As a result, the control lever 4 can be transferred from its emergency operation state shown in FIG. 1 with solid lines into the normal operation functional state shown in dash-dotted lines. The control lever 4 executes a counterclockwise movement about its axis 5. A similar pivoting movement of the control lever 4 is caused or can be realized by the fact that, according to the embodiment, the anti-theft lever 2 is equipped with a cam 2a moving against a lower lever arm of the three-armed control lever 4.

In fact, the transition of the securing lever or anti-theft lever 2 from its “unsecured” position shown in FIG. 1 to the “secured” position shown in FIG. 2 results in the cam 2a in question moving against the downwardly projecting lever arm of the control lever 4 and in this way pivoting the control lever 4 about its axis 5 in a counter-clockwise direction. This can be seen in the transition from FIG. 1 to FIG. 2.

The special feature of the invention is that the control lever 4 can be actuated both by means of the motor-operated anti-theft lever 2 and by the electromagnetic unit 8. The electromagnetically actuated securing lever 2 compulsorily acts on the control lever 4 in a “secured” first actuating direction. This “secured” first actuating direction corresponds to the fact that the electromotive drive 3 moves the securing lever and/or anti-theft lever 2 from the position in FIG. 1 to the right into the functional position according to FIG. 2. As a result, the cam 2a of the securing lever 2 moves against the control lever 4 and ensures that the control lever 4 is forced to pivot counterclockwise about its axis 5, and assumes the position indicated in FIG. 2. The pivoting and/or the action on the control lever 4 is obligatory because the energization or non-energization of the electromagnetic unit 8 plays no role in this context.

If, however, the motor-operated securing lever or anti-theft lever 2 is actuated in a second, “unsecured” actuating direction, the control lever 4 is not actuated. This second, “unsecured” actuating direction corresponds to the fact that the securing lever 2 is moved back to the left from the functional position in FIG. 2 into the functional position in FIG. 1 by means of the motor drive 3, as indicated by dash-dotted lines in FIG. 2. Since the cam 2a does not interact with the control lever 4, the control lever 4 is not actuated in this second, “unsecured” actuating direction.

Rather, the design is such that the control lever 4 assumes the position shown in solid lines in FIG. 1 in this second actuating direction of the securing lever 2 as shown in FIG. 1, when the electromagnetic unit 8 is not energized. This corresponds to the position in emergency operation of the control lever 4, in which it ensures that the locking lever 1 is coupled. If, however, the electromagnetic unit 8 is energized in the functional position according to FIG. 1, the control lever 4 moves into its position indicated therein by dash-dotted lines, because the electromagnetic unit 8 ensures the magnetic attraction of the control lever 4. As a result, the control lever 4 is pivoted counterclockwise about its axis 5 against the force of the spring 6.

As a result, the control pin 4a migrates from the predominantly vertically oriented L-leg of the L-shaped actuating contour 7 upwards in the direction of the horizontal L-leg. An action on the locking lever 1 consequently leads to an idle stroke of the actuating lever chain 1, 2 and to the fact that the locking mechanism in the closed state cannot be opened. The actuating lever chain 1, 2 therefore assumes its “locked” state. In contrast, the solid position of the control lever 4 and consequently also the coupled locking lever 1 corresponds to the “unlocked” functional position.

During normal operation and when the electromagnetic unit 8 is energized, the locking lever 1 is uncoupled. In normal operation and in the “unsecured” functional position, the control lever 4 is in its basic position shown in dash-dotted lines in FIG. 1. This corresponds to the “locked” functional position. If there is a power supply failure of the electromagnetic unit 8 in this functional position, for example in the event of a crash, the locking lever 1 automatically goes into the coupled position and thus the “unlocked” functional position of the actuating lever chain 1, 2. This is because the failure of the power supply of the electromagnetic unit 8 results in the electromagnetic unit 8 no longer being able to magnetically attract the control lever 4. As a result, the control lever 4 is moved by means of the spring 6 assigned to it, starting from the dot-dash position, clockwise about its axis 5 into the position shown in solid line. At the same time, the locking lever 1 is coupled and the actuating lever chain 1, 2 as a whole assumes its “unlocked” position. Accordingly, the motor vehicle lock is in an unlocked state, especially in the event of a crash, so that arriving rescue personnel are provided with unhindered access to an associated vehicle door.

The securing lever 2 is designed to be substantially linear. The locking lever 1 can be mounted on the securing lever 2 so that it can rotate as a whole. Of course, this is only by way of example and by no means mandatory. The electromotive drive 3 may in turn have an electric motor (not shown) which, via an output wheel, including actuating cams, ensures the described predominantly linear movement of the securing lever or anti-theft lever 2.

1. A motor vehicle lock, comprising:
an actuating lever chain with at least one locking lever and a securing lever,
at least one electromotive drive for actuating the securing lever and/or the locking lever,
an electromagnetic unit, and a control lever for coupling and uncoupling the locking lever, wherein the control lever is actuated both by the motor-operated securing lever and by the electromagnetic unit.

2. The motor vehicle lock according to claim 1, wherein the motor-operated securing lever, in a first “secured” actuating direction, forces the control lever to uncouple the locking lever.

3. The motor vehicle lock according to claim 2, wherein the motor-operated securing lever, in a second, “unsecured” actuating direction, does not act on the control lever.

4. The motor vehicle lock according to claim 3, wherein the control lever couples the locking lever in the second unsecured actuating direction of the securing lever and when the electromagnetic unit is not energized, and uncouples the locking lever when the electromagnetic unit is energized.

5. The motor vehicle lock according to claim 1, wherein the locking lever in a coupled state corresponds to an unlocked position of the actuating lever chain in which the actuating lever chain is mechanically closed, and the locking lever in an uncoupled states corresponds to a locked position of the actuating lever chain in which the actuating lever chain is mechanically interrupted.

6. The motor vehicle lock according to claim 1, wherein the locking lever is uncoupled during normal operation and when the electromagnetic unit is energized, and assumes a locked functional position.

7. The motor vehicle lock according to claim 6, wherein the locking lever changes to a coupled, unlocked position in the event of a power supply failure of the electromagnetic unit.

8. The motor vehicle lock according to claim 1, wherein the electromotive drive acts on the securing lever in a linear direction.

9. The motor vehicle lock according to claim 1, wherein the locking lever is mounted on the securing lever.

10. The motor vehicle lock according to claim 1, wherein a pin of the control lever includes a control pin that engages in an actuating contour on the locking lever.

11. The motor vehicle lock according to claim 10, wherein the actuating contour is L-shaped, so that according to a position of the control pin inside the actuating contour, different coupled or uncoupled functional positions of the locking lever are realized.

12. The motor vehicle lock according to claim 1, wherein the control lever is made of a magnetizable material.

13. The motor vehicle lock according to claim 3, wherein the second unsecured actuating direction is opposite relative to the first secured actuating direction.

14. The motor vehicle lock according to claim 1, further comprising a spring that biases the control lever towards a coupled position of the locking lever.

15. The motor vehicle lock according to claim 1, wherein the securing lever includes a cam that acts against the control lever.

16. The motor vehicle lock according to claim 15, wherein control lever is a three-armed lever, and the cam of the securing lever acts against a first arm of the three arms of the control lever.

17. The motor vehicle lock according to claim 16, wherein the first arm of the three arms of the control lever is opposite to a second arm of the three arms of the control lever that is acted on by the electromagnetic unit.

18. The motor vehicle lock according to claim 17, wherein a third arm of the three arms of the control lever interacts with the locking lever.
